(19) United States
(12) Patent Application Publication
(10) Pub. No.: US 2025/0327148 A1
(43) Pub. Date: Oct. 23, 2025

(54) METHOD OF ORE PROCESSING

(71) Applicant: Element Zero Pty Limited, Malaga (AU)

(72) Inventors: Bjorn WINTHER-JENSEN, Scarborough (AU); Bartlomiej KOLODZIEJCZYK, Hadfield (AU)

(21) Appl. No.: 19/122,145

(22) PCT Filed: Oct. 19, 2023
(86) PCT No.: PCT/AU2023/051041

§ 371 Date: Apr. 17, 2025

(30) Foreign Application Priority Data
Oct. 20, 2022 (AU) 2022903090

(51) Int. Cl. C22B 3/12; C25C 1/00

(52) U.S. Cl. CPC C22B 3/12; C25C 1/00

(57) ABSTRACT

The invention relates to a method of providing an ore concentrate solution suitable for beneficiation processing, the method including the step of contacting an ore with one or more metal bases at elevated temperature. The one or more metal bases at elevated temperature may form a super-alkaline media that partially or fully dissolves the ore. Typically, the one or more metal bases are alkali metal bases, preferably chosen from lithium hydroxide, sodium hydroxide, potassium hydroxide, rubidium hydroxide or caesium hydroxide, or alkaline earth bases, preferably chosen from calcium hydroxide, barium hydroxide or strontium hydroxide. The one or more metal bases at elevated temperature may form a super-alkaline media that partially or fully dissolves the ore.

### FIELD OF INVENTION

The present invention relates to the field of ore processing.

In one form, the invention relates to processing ores to provide valuable products such as metals, metal compounds, metalloids or intermediate compounds suitable for further down-stream processing.

In another aspect the present invention is suitable for providing processed ore for down-stream beneficiation processes.

In one particular aspect the present invention is suitable for providing processed ore for down-stream electrometallurgical processes such as electrodeposition or electrowinning.

It will be convenient to hereinafter describe the invention in relation to iron ore, however it should be appreciated that the present invention is not so limited but extends to a wide range of ores, and a wide range of valuable products including products based on metals and metalloids. Furthermore, it will also be convenient to describe the invention in relation to provision of processed material for electrometallurgy but can be extended to other forms of extractive metallurgy and ore beneficiation processes.

### BACKGROUND ART

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

The term ‘crude ores’ refers to ores, metals, metalloids, minerals, and other products containing mineral substances that are mined or otherwise removed from the ground and may be sized or crushed. Crude ores are subjected to further treatment or concentrating as part of industrial processing to separate valuable minerals from waste rock or gangue. “Beneficiation’ is a term used to refer to any treatment that improves or benefits the economic value of ore, to provide a higher grade product (called an ‘ore concentrate’) and a waste stream.

The further treatment typically includes extractive metallurgy to remove metals from natural mineral deposits. Extractive metallurgy techniques are commonly grouped into four categories: hydrometallurgy, pyrometallurgy, ionometallurgy and electrometallurgy.

Electrometallurgy involves metallurgical processes carried out in some form of electrolytic cell. The most common types of electrometallurgical processes are electrorefining and electrowinning.

Electrowinning is an electrolysis process used to recover metals from aqueous solution, usually after an ore has undergone one or more hydrometallurgical processes. An electrical current is passed from an inert anode through a leach solution containing the dissolved metal ions so that the metal is deposited onto a cathode and recovered.

Electrorefining uses a similar process to remove impurities from a metal. In electrorefining, the anode consists of the impure metal to be refined. The impure metallic anode is oxidized and the metal dissolves into solution. The metal ions migrate through the acidic electrolyte towards the cathode where the pure metal is deposited.

Ionometallurgy uses ionic liquid or eutectic melts to extract and or convert metals and minerals.

Apart from metals, many other commercially valuable products are derived from ores. For example, silica is an abundant, and chemically complex material found in several minerals, particularly quartz. It is extremely valuable to the microelectronics, food, and pharmaceutical industries.

The mining industry is constantly seeking ‘green’ ore processing technology to reduce emissions and waste.

For example, the steel industry accounts for about 7% of global carbon dioxide emissions and reducing carbon pollution from iron ore processing is important in efforts to avoid further climate change. Accordingly, in recent times there has been a focus on developing green iron—a higher value form of iron that has been stripped of impurities to leave purer iron without using processing that creates carbon dioxide emission. There is a worldwide effort to reduce carbon emissions by employing hydrogen-based steelmaking using blast furnaces or direct reduced iron plants followed by electric arc furnaces to replace fossil fuels but requires pellets of high-grade iron ore with low impurity content.

A limited quantity of high-grade ore is currently mined, mostly in the Americas, Europe and the Middle East. As supplies of high-grade ore are mined-out, it will be necessary to exploit lower-grade ores. Countries which already mine lower-grade ores, will need to further refine the crude product to make it suitable for reduction with hydrogen in blast furnaces or direct reduced iron plants in order to compete with suppliers of higher grade ore and to meet the expectations of overseas ore processors.

Australia has for many years relied on direct shipping ore—that is, ore that can be simply dug up and exported without further processing or with very limited processing, (such as blending or drying). The three main types of Australian iron ore are hematite, goethite and magnetite. Crude hematite/goethite is higher grade, and deposits are dwindling while magnetite deposits are large and comparatively low grade—but can be used to produce very high-grade concentrates.

Iron ore mining is a high-volume, low-margin business. It is capital intensive and requires substantial investment in infrastructure. Producers must get the best return from their product and the return depends heavily on iron ore grade and demand. Over the last 10 years, the premiums for high grade ore and discounts for low grade ore have increased, causing steelmakers to demand higher grade ore with less impurities.

The grade of Australian iron ore has declined over recent years and miners are experiencing significant depletion of their reserve deposits. In order to compete with other iron ore producers Australia must develop options for production of higher grade iron ore or its derivatives.

Various pathways have been evaluated to produce green iron, including electrochemically converting iron ore to iron at a wide range of temperatures (60 to 2,000° C.) without coal, natural gas, or other reductants, and using green hydrogen as green reductant to replace fossil fuel based reductants in blast furnaces of DRI plants. However, it has proved difficult to make green processes economically viable and efficient. Green pyrometallurgical processes also rely on a consistent, uninterrupted source of sufficient power, but this can be difficult to supply in remote mining areas where crude ore processing is carried out due to highly intermittent nature of wind and solar power generation.

### SUMMARY OF INVENTION

An object of the present invention is to provide a method of conversion and extraction of ores.

Another object of the present invention is to provide a green process, or at least a process that facilitates green processing of ores.

A further object of the present invention is to alleviate at least one disadvantage associated with the related art.

It is an object of the embodiments described herein to overcome or alleviate at least one of the above noted drawbacks of related art systems or to at least provide a useful alternative to related art systems.

In a first aspect of embodiments described herein there is provided a method of producing an ore concentrate solution, the method including the step of contacting ore with one or more metal bases, preferably alkali metal or alkaline earth bases, at elevated temperature. Preferably the ore concentrate solution is suitable for downstream beneficiation processing, such as extractive metallurgy.

The ore fed into the process of the present invention is typically a crude ore but may be an ore that has undergone some refinement to become a concentrated ore. Once the ore has been treated according to the method of the present invention to provide an ore concentrate solution, it can readily be supplied to downstream processes, such as electrometallurgical extraction processes. Thus, it is possible to avoid traditional concentration processes such as flotation, electrostatic separation, or magnetic separation or dewatering that are inefficient in terms of energy consumption.

Typically, ore for use in the present invention is any crude ore, or ore concentrate comprising a metal or metaloid. Preferably the ore is chosen from the group comprising one or more of the following: iron ore including hematite, goethite, magnetite, titanomagnetite and pisolitic ironstone; aluminium containing ores including bauxite, cryolite and corundum; gold ores including gold-polysulfide, gold-quartz, gold-telluride, gold-tetradymite, gold-antimony, gold-bismuth-sulfosalt, gold-pyrrhotite, and gold-fahlore; manganese containing ores such as romanechite, manganite hausmannite and rhodochrosite; lead ores including galena, cerrusite and anglesite; zinc ores including calamine and smithsonite; cobalt containing ores; uranium containing ores; copper containing ores including copper pyrite, chalcopyrite, bornite, covellite, chalcocite, malachite, cuprite and copper glance; nickel containing ores such as laterites and magmatic sulphide deposits; silver containing ores such as argentite; tin containing ores such as cassiterite, tinstone, stannite or cylindrite; and quartz. In a particularly preferred embodiment the ore is iron ore, which is particularly rich in iron oxides, particularly in the form of magnetite (Fe₃O₄), hematite (Fe₂O₃), goethite (FeO(OH)), limonite (FeO(OH)·n(H₂O)) or siderite (FeCO₃).

In another preferred embodiment the ore is an ore concentrate that includes species such as nickel oxide, nickel hydroxide or nickel sulphide.

In a further preferred embodiment the ore is an ore concentrate that includes species such as copper sulphide or copper-iron sulphide.

The metal base or bases at elevated temperature comprise a super-alkaline media. Upon contact with the metal base, the ore fully or partially dissolves and/or metal containing moieties are chemically converted to solvable species. Without wishing to be bound by theory it is believed that sulphide ores, for example, are converted to oxides.

Additional compounds may facilitate the dissolution or chemical conversion of the ore. In particular, the addition of silicates may promote dissolution or chemical conversion of the ore, particularly ore concentrates.

Alkali metal or alkaline earth bases suitable for use in the present invention are preferably hydroxides, although other bases such as metal oxides or metal ammonium species may also be used.

Typically, the metal base is chosen from alkali metal bases such as lithium, sodium, potassium, rubidium or caesium hydroxide, or alkaline earth bases such as calcium, barium or strontium metal hydroxides. In a particularly preferred embodiment, the metal base is chosen from lithium hydroxide, sodium hydroxide, potassium hydroxide or calcium hydroxide. In a particularly preferred embodiment, the super-alkaline media comprises 45 wt % to 100 wt % sodium hydroxide and/or potassium hydroxide.

One or more metal bases may be contacted with the ore, and combinations of metal bases may be in the form of a eutectic mixture. Eutectic mixtures of sodium, potassium and/or lithium hydroxide is particularly preferred. In some embodiments, for economic reasons NaOH is preferred but pure NaOH may not be as efficient as the combination of NaOH with KOH to form a eutectic system.

The super-alkaline media comprising alkali metal or alkaline earth bases are contacted with the ore at elevated temperature, preferably a temperature above 160° C., or above 200° C., preferably above 250° C., more preferably above 300° C. In a particularly preferred embodiment, the alkali metal or alkaline earth bases are contacted with the ore at a temperature of 160° C. to 400° C., preferably 200° C. to 350° C., more preferably 250° C. to 350° C.

For example, with reference to eutectics, most mixtures of NaOH and KOH have lower melting points than the constituent compounds. For a 1:1 molar ratio of NaOH:KOH, the eutectic forms at 170° C. If adsorbed or crystalline water is present, such as in a 1:1:1 ratio of NaOH:KOH:H₂O, the temperature of formation of the eutectic can be below 100° C.

Once the super-alkaline media is contacted with the ore and the ore is partially or fully dissolved, the combination may be cooled to form a solid and then re-heated for further processing.

Molten metal bases, particularly hydroxides often include impurities such as water. Preferably metal bases incorporated in the super-alkaline media of the present invention will include water in amounts of no more than one mole of water per more of hydroxide. It is also possible to drive off water from the super-alkaline media by short term heating of the super-alkaline media to higher temperatures (i.e., >450° C.). A shield of inert gas over the super-alkaline media can then be used to restrict or prevent reabsorption of water.

The metal bases used in the present invention may include small amounts of chemical impurities. For example, sodium hydroxide may form, or include small amounts of sodium carbonate (Na₂(CO₃)).

In a second aspect of embodiments described herein there is provided a method of refining an ore, the method including the steps of:
(i) contacting the ore with one or more metal bases, preferably alkali metal or alkaline earth bases, at elevated temperature;
(ii) feeding a solution formed in step (i) to a beneficiation process.

In one aspect of the present invention, the beneficiation process may be, for example, an extraction process for removing silica and/or alumina or other impurities including titania, phosphorus and manganese.

In another aspect of the present invention, the beneficiation process may be, for example, an extractive metallurgical process, preferably electrometallurgy, to deposit metal from the solution.

Upon contact of the ore with one or more metal bases, the ore may fully or partially dissolve or chemically convert moieties in the ore to solvable species. While ultimately the solution thus formed may be fed to a downstream extractive metallurgical process such as an electrochemical process for selective electrodeposition of target metals, it may be advantageous to include a step facilitating extraction of particular elements, such as nickel, cobalt, molybdenum, lithium, aluminium and silicon. The solution may be subjected to further beneficiation processes.

Therefore, in a third aspect of embodiments described herein there is provided a method of concentrating an ore, the method including the steps of:
(i) contacting the ore with one or more metal bases, preferably alkali metal or alkaline earth bases, at elevated temperature to form an ore concentrate solution;
(ii) extracting one or more components of the ore from the ore concentrate solution;
   and optionally,
(iii) feeding the extracted solution to an extractive metallurgical process, preferably electrometallurgy, to deposit metal;
   and optionally,
(iv) passing the extracted ore concentrate solution to further beneficiation processes.

In a fourth aspect of embodiments described herein there is provided a method of concentrating an ore, the method including the steps of:
(i) contacting the ore with one or more metal bases, preferably alkali metal or alkaline earth bases, at elevated temperature,
(ii) converting sulphide species in the ore to oxides in solution;
(iii) extracting one or more of the oxides from the solution; and optionally,
(iii) passing the extracted oxides to further refining processes.

In a fifth aspect of embodiments described herein there is provided a method of concentrating an ore, the method including the steps of:
(i) contacting the ore with one or more metal bases, preferably alkali metal or alkaline earth bases, at elevated temperature;
(ii) forming a solution comprising dissolved components from the ore;
(iii) removing the components from the solution; and optionally
(iv) forwarding the purified solution from step (iii) to a downstream beneficiation process.

Components removed from the solution may include aluminium and silicate species. The components removed from the solution may be converted into valuable commercial products such as geo-polymers (inorganic aluminosilicate polymers) or zeolites (generally expressed as Mⁿ⁺_{1/2}(AlO₂)⁻(SiO₂)ₓ·yH₂O where Mⁿ⁺_{1/2} is a metal ion, typically Na⁺, K⁺, Ca²⁺, Mg²⁺, or H⁺.

In another aspect, the present invention provides a concentrated ore, or a refined ore, produced according to the method of the present invention.

In yet another aspect, the present invention provides commercial products produced according to the method of the present invention. In a particularly preferred embodiment the commercial product is a metal.

Other aspects and preferred forms are disclosed in the specification and/or defined in the appended claims, forming a part of the description of the invention.

In essence, embodiments of the present invention stem from the realization that a super-alkaline media can be used to convert ore, including crude ore, into useful concentrated ores or commercially valuable chemical products.

Advantages provided by the process of the present invention comprise the following:
can be carried out at ambient pressure;
low energy consumption;
high efficiency conversion of ores to valuable chemical species;
high efficiency refinement of ores, particularly crude ores;
provision of an ore feedstock to further downstream ore refining processes; and
provision of chemical species suitable for processing into valuable chemical products.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 illustrates the use of molten hydroxides as a super alkaline media at different temperatures.

FIG. 2 is a plot illustrating deposition of iron from a solution formed by contacting hematite ore with an NaOH/KOH eutectic at five temperatures—250° C., 275° C., 300° C., 325° C. and 350° C. The plot records current (I) in mA against voltage (E) in volts.

FIG. 3 is a plot illustrating the effect of removing water from the super-alkaline media. The plot records current (I) in mA against voltage (E) in volts.

### DETAILED DESCRIPTION

The present invention provides a method of refining ore, such as crude ore or concentrated ore, for downstream processing, particularly extractive metallurgy. The method includes the step of contacting ore with one or more metal bases, preferably a super alkaline media formed from alkali metal and/or alkaline earth bases, at elevated temperature. Where two or more alkali metal and/or alkaline earth bases are used, typically the super alkaline media will be in the form of a eutectic.

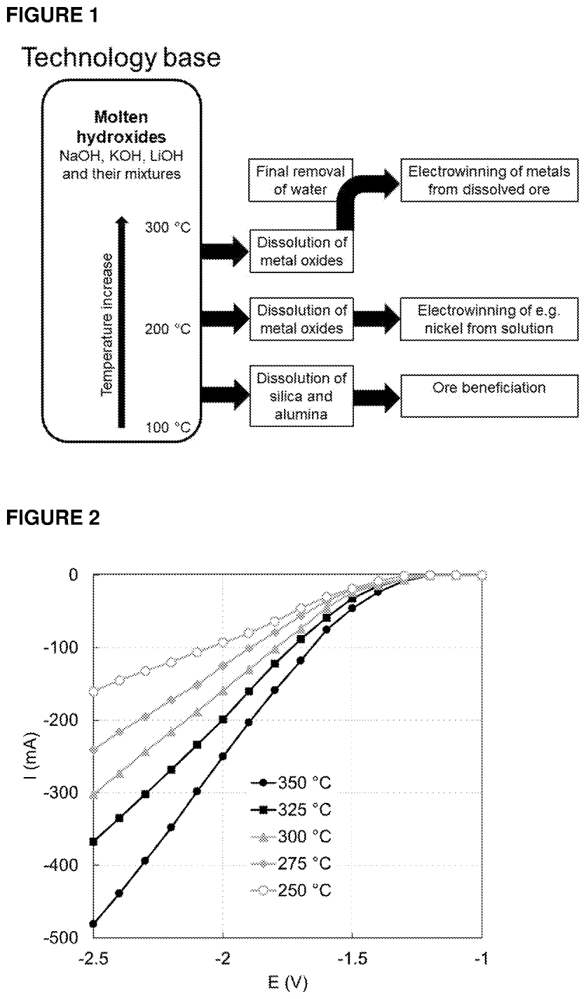

FIG. 1 illustrates the use of molten hydroxides as a super alkaline media at different temperatures. At lower temperatures, around 100° C., the super alkaline media is particularly useful for dissolving species such as silica and alumina from ore. The concentrated ore may be passed on to other beneficiation processes, and the alumina or silica used as valuable products. At medium temperatures, around 200° C., the super alkaline media is particularly useful for dissolution of certain metal oxides which can be recovered by subjecting the solution to electrowinning processes. At higher temperatures, around 300° C., the super alkaline media is particularly useful for dissolving metal oxides such as iron which can be recovered by subjecting the concentrated ore to electrowinning processes.

In particular, the super alkaline media can be used to:
Fully or partially dissolve or chemically convert metal containing ore to solvable species followed by electrochemical deposition of metal from this solution;
Fully or partially dissolve or chemically convert ore to solvable species facilitating extraction of particular elements (such as nickel, cobalt, molybdenum, aluminium, lithium, and silicon) followed by selective electrodeposition of the element from the molten hydroxide or followed by chemical processing of the dissolved element;
Fully or partially convert sulphide ore or concentrate (such as iron or nickel) to oxides followed by conventional processing of these oxides (chemical and/or electrochemical—but not necessarily in the molten hydroxide);
Partially dissolve mineral ores to remove components (such as alumina and silica) followed by down-stream processing of the purified ore and with the possibility of conversion of the removed components into commercial products like geo-polymers or zeolites.

### Ore Concentrates

For any of the abovementioned processes, additional compounds may be used to facilitate the dissolution of the ore or chemical conversion of components into soluble species. In particular, the addition of silicates may enhance the conversion of the solid oxide into metal-silicates that form a solution with the super-alkaline media. For example, the addition of silicates such as quartz, feldspar, mica, amphibole, pyroxene, olivine or aluminium-silicate may be advantageous, particularly for ore concentrates.

When ore concentrates are exposed to molten hydroxides initially, they may form a solid metal oxide. For example, nickel hydroxide or nickel sulphide concentrates may initially form a solid iron-nickel oxide. This solid oxide may also contain small amounts of other elements such as iron, manganese, magnesium, copper and cobalt (but very little silicate).

By controlling the process parameters such as temperature and silica concentration it is possible to perform selective dissolution of metals contained in the solid oxide. Undesirable oxides can remain undissolved in the solid oxide, controlling the purity or species in the solution.

Metals may be electro deposited directly from the solution or be isolated by conventional means in a down-stream process (for example, neutralization followed by conventional electrowinning).

For sulphide concentrates this procedure is particularly advantageous because it eliminates the need for the conventional high temperature ‘roasting’ process.

### EXAMPLES

The present invention will be further described with reference to the following non-limiting examples:

### Example 1—Haematite

The method of the present invention was applied to a sample of iron ore “dust” from Western Australia, comprising approximately 24 wt % Si, approximately 21 wt % iron and 1 wt % Ni.

A super-alkaline media was formed, comprising a eutectic of NaOH/KOH in 1:1 molar ratio at 200° C. No attempt to remove water from the eutectic was performed and it is known that the equilibrium water content at this temperature is 8 to 10 wt % depending on NaOH:KOH ratio. Upon contact of the super-alkaline media with the iron ore dust, a solution formed comprising aluminates, silicates, and some iron oxides (magnetite, haematite, goethite, limonite, and siderite). However, the majority of iron oxides remain in the solid state at 200° C. The concentration of iron oxide species in the solution increased with increasing temperature and thereby decreasing water content at atmospheric pressure, reaching full dissolution at 350° C.

Haematite was recovered from the solution at 200° C. by simple decanting of the liquid followed by rinsing with water. Analysis indicated that the haematite to have 93 wt % purity (61% iron), which is considered ‘export grade’.

### Example 2—Nickel

The solution formed in Example 1 was maintained at 200° C. and atmospheric pressure and fed an electrolysis cell in an electrowinning process. The solution comprised nickel originating from the approximately 1% nickel in the original ore.

An electric current was passed from an inert gold anode, through the solution and nickel and iron were deposited onto the cathode in an electroplating process in a ratio of 7:1 (Ni:Fe).

### Example 3—Ore Dissolution in Molten Hydroxide

A super-alkaline media was formed, comprising a NaOH/KOH (1:1 molar ratio) eutectic at 300° C. Haematite ore was progressively added and a solution formed. At low concentrations of haematite, the solution was light green, the colour becoming more intense. At a concentration of 200 g of haematite in one litre of the super-alkaline media at 300° C., the solution was an intense green/black colour.

Ores of different quality having Fe content from 48% to 62% Fe were similarly tested and all showed the same dissolution behaviour.

The resulting solution exhibited low viscosity (appearing to behave similarly to water) above 250° C. which is particularly suitable for electrochemical processing. The solution was cooled to 25° C., at which temperature it became solid. The solid material could be re-melted and subjected to further metallurgical extraction.

At higher concentrations of haematite ore in the super-alkaline media, a solution formed in the precipitate. When the solution was cooled to 25° C. and then re-melted, the precipitate remained an amorphous solid that would not dissolve or melt when subjected to temperatures up to 300° C.

Both haematite and goethite are iron oxides in which iron is in oxidation state (III), imparting the characteristic red ‘rust’ to red-brown colour to the ore. The development of a distinctive green colour indicates that at least some of the iron (III) has changed oxidation state during the formation of the solution. Without wishing to be bound by theory the green colour of the solution could possibly be due to:
formation of soluble iron (II) silicates; and/or
formation of ‘green rust’ comprising mixed valence (oxy)hydroxides having iron in mixed oxidation states (+2 and +3). Low melting point iron silicates exist in both Fe(II) and Fe(III) species, with only the Fe(II) silicate being green; and/or
formation of other iron compounds in solution.

A few possible reaction schemes support the observed conversion to Fe(II), all of which suggest the generation of oxygen, which is consistent with the observation of bubbles when the super-alkaline media contacts the ore according to the following:
2Fe₂O₃+4NaOH→4(Na⁺, HFeO₂⁻)+O₂
Fe₂O₃+2NaOH→H₂O+O₂+2FeO+2Na (The sodium would react with water and form NaOH and H₂; FeO is soluble in alkaline media.)
2Fe₂O₃→4FeO+O₂
2Fe₂O₃+2H₂O→4FeOOH, followed by 4FeOOH+2H₂O→4Fe(OH)₂+O₂

The generation of oxygen could be useful for novel applications such as the mining or refining of minerals in anaerobic or oxygen deficient atmospheres. This could facilitate mining ore resources on the moon, on asteroids or planets, such as Mars.

### Example 4—Influence of Temperature on Iron Deposition

The solution of Example 3 was separately fed into an electrolysis cell in an electrowinning process kept at atmospheric pressure and deposition was carried out in the cell at temperatures of 250° C., 275° C., 300° C., 325° C. and 350° C. respectively.

An electric current was passed from an inert gold anode, through the solution and iron was deposited onto an iron cathode in an electroplating process. It was noted that during the deposition process some parasitic hydrogen evolution also occurred.

FIG. 2 is a plot illustrating the results of the iron deposition from each solution. The plot illustrates successful deposition at 250° C., and that deposition rate increases with increasing temperature. The increase in current with increase in temperature accounts for both decrease in solution viscosity and normal activity increase.

### Example 5—Influence of Water in the Super-Alkaline Media

Many alkali metal or alkaline earth bases are hygroscopic. Hydroxides in particular are very hygroscopic and even ‘pure’ commercially available hydroxides often contain up to 10 wt % water at 200° C.

The presence of water in electrochemical processing such as electrodeposition can lead to parasitic hydrogen evolution, due to splitting of water. This side reaction reduces the overall efficiency of the electrodeposition reaction. Removal of water is important in metal deposition, particularly iron deposition as the thermodynamic reduction potentials for water and iron oxides favour hydrogen evolution over iron deposition.

Water can be effectively driven off by short term heating of the super-alkaline media to higher temperatures (i.e., >450° C.). A shield of inert gas should then be maintained over the solution during deposition to restrict or prevent reabsorption of water. Prolonged heating of the solution to >350° C. during deposition also removes enough water to substantially reduced hydrogen evolution.

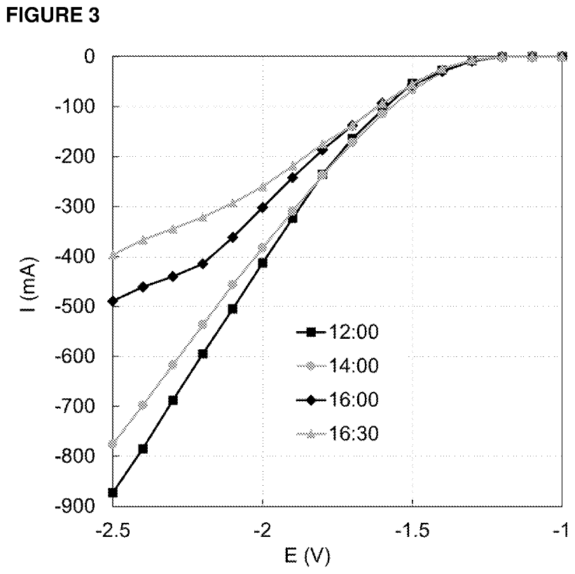

FIG. 3 is a graph illustrating the effect of removing water from the super-alkaline media. The graph records current (I) in mA against voltage (E) in volts. The first plot was made at 12.00 μm, the second at 14.00 pm the third at 16.00 μm and the final plot at 16.30 μm. The increase in slope of the 16.00 pm graphs at about-2.2 Volts occurs as water is driven out of the super alkaline media. Overall, the graph illustrates prolonged heating at 350° C. successfully drives off water, but the process is quite slow. The plot also reflects the ‘real’ iron deposition rate.

### Example 6—Dissolution/Conversion of Iron Ore as a Function of Impurities

Three dried hematite ore samples (dried at 200° C. for 2 hours) having the same Pilbara origin but with different iron content (55%, 60% and 62% Fe, respectively) were reacted with molten hydroxide in three Teflon lined containers.

A 20 g portion of each ore sample was added to 48 g of 1:1 (molar) NaOH:KOH at 310° C. and stirred for one minute and dark green solutions developed. The temperature was kept at 310° C. for four hours and the samples were then allowed to cool to room temperature under Teflon lids.

To determine the dissolution/conversion of ore, the Teflon liners with the ore/hydroxide samples were immersed in 150 ml of 5.5 M HCl and allowed to react for 24 hours with agitation. The liquor was then decanted off and 50 ml for fresh 5.5 M HCl was added and allowed to react for 2 hours and decanted again. The unreacted ore was then washed three times in distilled water and dried in air at 150° C. before weighing. The characteristics of each sample are listed in Table 1.

TABLE 1

| | | | | |
|---|---|---|---|---|
| Fe in ore | 62% | 60% | 55% | HCl control |
| Fe₂O₃ in ore | 89% | 86% | 70% | |
| Solid after test (g) | 10.9 | 9.972 | 7.822 | 19.588 |
| Dissolved in test (g) | 9.1 | 10.028 | 12.178 | 0.412 |
| wt % ore in solution | 19.0 | 20.9 | 25.4 | |

It can be seen from Table 1 that the saturation of dissolved ore in molten hydroxide increases with the increased quantity of impurities in the ore. This is not unexpected as the main impurities—silica and alumina—are well-known to readily dissolve under alkaline conditions. However, the increase in dissolved ore is larger than the additional quantity of impurities going from 62% to 60% and to 55% Fe content. This suggests that the impurities are aiding the dissolution of the iron oxides in molten hydroxides.

Two control experiments were conducted using the 60% Fe ore sample. In one experiment the reaction time at 310° C. was decreased from four to one hour. This did not result in a change in the measured saturation of dissolved ore, which strongly suggests that the reaction/conversion time is well below one hour under the conditions used.

In a separate experiment, 20 g of 60% Fe ore was allowed to react with 200 ml of 5.5 M HCl for 26 hours. The undissolved ore was rinsed in water, dried, and weighed. The exposure to HCl only caused a very minor decrease in weight (see Table 1), meaning that the effect seen with exposure to molten hydroxide is caused by the hydroxide, not by the titration with HCl.

### Example 7—Dissolution of Manganese(IV) Oxide (MnO₂)

Manganese oxide is a common impurity in Australian iron ore, usually limited to a range of up to about 1%. The manganese impurities are rarely part of the iron oxide lattice, but rather occur as well-defined grains of MnO₂. The low level of manganese oxides in the ore makes it difficult to determine what happens to it during the dissolution process of the (iron) ore. To address this, 5 wt % of synthetic MnO₂ was added to 1:1 (molar) NaOH:KOH at 300° C. The molten hydroxide immediately turned black and gradually shifted to dark green/black after 24 hours without precipitates. Based on the colour observed at that temperature, it is unlikely that manganese(II) hydroxide formed because it is white and decomposes at ˜140° C. Instead, the green colour indicates partial formation of the manganate(VI) ion.

Electrodeposition was attempted from the molten hydroxide solution at 300° C. under conditions known to produce iron from dissolved iron ore. Nickel foil was used as both anode and cathode material and a voltage of 1.8 V was applied between the electrodes. A bright green solution was formed around the anode, indicating formation of manganate as the oxidized product. The deposits on the cathode were analysed and found to be a mixture of manganese oxides, with the manganese mainly in oxidation states +2 and +4.

This experiment shows that metallic manganese is not likely to be deposited as the cathode product (pure or as an alloying element) under the conditions used when dissolved iron species are electrodeposited. Instead, trace impurities of manganese oxides are to be expected.

### Example 8—Dissolution of Molten Hydroxide Followed by Separation at High Temperatures

Sodium hydroxide (250 g) was allowed to melt at 335° C. in a heated lab scale thickener and 25 g of dried (400° C.) iron ore powder was added. After one hour when the ore was dissolved, the temperature was raised to 370° C. and kept at this temperature for one hour. The elevated temperature caused the dissolved iron species to de-hydrolyse and thereby phase separate from the bulk of molten hydroxide in the conical part of the thickener. This allowed the iron-rich intermediate to be removed from the thickener by gravimetric means.

The main impurities from the ore (silica and alumina) remained in solution in the molten hydroxide as silicates and aluminates. The process could be repeated by lowering the temperature to 335° C., adding more iron ore, raising the temperature again to 370° C. causing more iron rich intermediate to separate out.

The iron rich intermediate was added to a eutectic melt of sodium and potassium hydroxide and electrodeposition was carried out at temperatures in the 220° C. to 310° C. range.

The dissolution and separation can also be performed directly in the eutectic melt at high temperatures. However, this incurs additional cost because the more expensive potassium hydroxide is spent in the process by conversion to potassium silicates and potassium aluminates.

### Example 9—Dissolution of Iron Ore in Molten Hydroxide Eutectics Followed by Removal of Impurities from the Surface

Four kilograms of hydroxide eutectic (1:1 NaOH:KOH by weight) was heated in a vertical kiln having a nickel liner to 300° C. A sample of 400 g of dried iron ore (hematite, 55% Fe) was added and stirred for 30 minutes until all the iron ore was dissolved. The stirring was then switched off and the temperature was gradually and slowly decreased.

At temperatures close to the freezing point of the mixture (˜230° C. to 210° C.), a liquid-liquid gravimetric phase separation occurred. The bottom phase contained the heavier, iron-rich species and the upper layer contained the impurity rich species (mainly silicates and aluminates). The impurity rich phase could be removed by carefully pumping the phase at the upper level of the solution.

When the temperature was further lowered (to 200° C.) a white crust formed on the surface of the solution, which was removed by simple mechanical means. Elemental analysis revealed that this crust contains up to 50% impurities in a hydroxide matrix.

These methods of separation of impurities in liquid or in solid form from the dissolved ore both provide practical methods for beneficiation prior to further processing of the iron-rich solution, for example, by electrowinning.

### Example 10—Magnetite Concentrate

A sample of 10 wt % of magnetite concentrate (67% iron, 5% silica, ˜50 μm particle size) was added to a mixture of molten NaOH and KOH (3:1 molar concentration) at 310° C. The magnetite concentrate dissolved quickly under stirring, forming a black-brown solution. This solution was used without further treatment for electrowinning of iron at 310° C.

The experiment was repeated with a 1:1 (molar) ratio of NaOH:KOH and the magnetite concentrate was dissolved at 310° C. After the dissolution was completed, the temperature was lowered to 240° C. before electrowinning of iron was performed.

### Example 11—Silica, Silicates and Quartz

Silica and other variations of the SiO₂ motif are known to easily dissolve in alkaline media and this is a significant aspect of various, established routes of industrial scale processing, such as for bauxite and spodumene minerals. However, these methods are based on using hydroxide solutions rather than molten hydroxides.

When 10 wt % of silica or sodium silicate powder was added to a molten hydroxide eutectic (1:1 NaOH:KOH) at 310° C. the silica or sodium silicate immediately started to react with the hydroxide, releasing water as a part of the reaction. The release and evaporation of water cooled the top of the molten hydroxide to below its melting temperature. This caused the formation of a solidified sponge atop of the molten hydroxide, stalling further reaction of silica due to poor thermal conductivity. To overcome this issue, silica was slowly added to the molten hydroxide over 48 hours, resulting in a clear and transparent solution.

The reaction of quartz with molten hydroxide has the same overall chemistry as silica but is significantly slower and thus does not cause the same issues with formation of a spongy crust/matrix. Practically, this allows leaching of quartz to be easily integrated in a dissolution-electrowinning (of silica) circuit.

### Example 12—Nickel Sulphide Ore and Concentrate

A West Australian nickel sulphide ore sample (2.0% Ni, 14.1% Fe, 0.2% Cu, 6.3% S and 9.9% MgO) with particle size less than 3 mm was added to an NaOH:KOH eutectic melt (1:1 by weight) at 250° C. (6 wt % ore, 94 wt % hydroxide). The ore instantly started to dissolve and was completely dissolved after 3 minutes, turning the clear molten hydroxide into an orange/brown solution.

The dissolved ore solution was used as an electrolyte in an electrowinning experiment where magnetic depositions were achieved with potentials as low as 1.4 V. The magnetic deposits were washed in water and then immersed in 5.5 M HCl where hydrogen evolution was detected, confirming the metallic nature.

### Example 13—Nickel Sulphide Ore and Concentrate

A sample of nickel sulphide concentrate from a West Australian nickel sulphide ore (13.6% Ni, 38.7% Fe, 1.1% Cu, 32.8% S and 3.5% MgO) with particle size less than 1 mm was added to an NaOH:KOH eutectic melt (1:1 by weight) at 250° C. (3 wt % concentrate, 97 wt % hydroxide). The concentrate dissolved quickly, within 2 minutes, in the molten hydroxide forming a deep red-brown solution. The dissolution occurred without any evolution of gases or vapour. The solution was left under a Teflon lid for 24 hours at 250° C. After this period, no precipitation was observed, and the colour remained unchanged but with increased intensity.

The dissolved concentrate solution was then used for electrowinning experiments. It was observed that electrochemical current flow had already started at cell voltages of 0.6 V and reached a low-current plateau at 0.9 V, before increasing rapidly again at 1.2 V. Cathode depositions at 1.0 V formed a thin coating with recognisable copper colour, indicating that copper could be selectively deposited from the solution, however the current densities were limited by the diffusion of low-concentration copper species in the solution.

Cathode depositions from the same solution, obtained at 1.6 V and 1.8V cell voltage were magnetic and produced hydrogen when exposed to diluted HCl solutions. Notably, at a cell voltage of 1.8 V, current densities above 200 mA/cm² were measured, which indicates very high diffusivity of the dissolved metal species in the molten hydroxide solution.

Copper, nickel and iron in the sulphide ores and concentrate are contained in sulphide structures and their electrodeposition from the molten hydroxide solution confirms that the sulphide bonding structures have been broken during the dissolution. It is therefore anticipated that other sulphide ores, for example, copper-iron sulphide ores such as chalcopyrite and their concentrates, will undergo a similar dissolution process in molten hydroxides.

It is worth noting that iron only exists in oxidation state +2 in sulphide ores, where in most commercial oxides all (hematite and goethite) or most (magnetite) iron is in oxidation state +3. From an (electro) reduction perspective this means that significantly less current/energy is needed for reduction of iron from sulphide structures than from oxides.

While this invention has been described in connection with specific embodiments thereof, it will be understood that it is capable of further modifications. This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures.

When a Markush group or other grouping is used herein, all individual members of the group and all combinations and sub-combinations possible of the group members are intended to be individually included in the disclosure. Every combination of components described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

As used herein, “comprising” is synonymous with “including,” “containing,” or “characterized by,” and is inclusive or open-ended and does not exclude additional, unrecited elements or method steps. As used herein, “consisting of’ excludes any element, step, or ingredient not specified in the claim element. As used herein, “consisting essentially of’ does not exclude materials or steps that do not materially affect the basic and novel characteristics of the claim. The broad term “comprising” is intended to encompass the narrower “consisting essentially of’ and the even narrower “consisting of.” Thus, in any recitation herein of a phrase “comprising one or more claim element” (e.g., “comprising A), the phrase is intended to encompass the narrower, for example, “consisting essentially of A” and “consisting of A” Thus, the broader word “comprising” is intended to provide specific support in each use herein for either “consisting essentially of” or “consisting of.” The invention illustratively described herein suitably may be practiced in the absence of any element or elements, limitation or limitations which is not specifically disclosed herein.

One of ordinary skill in the art will appreciate that materials and methods, other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by examples, preferred embodiments and optional features, modification and variation of the concepts herein disclosed may be resorted to by those skilled in the art, and that such modifications and variations are considered to be within the scope of this invention as defined by the appended claims.

Each reference cited herein is incorporated by reference herein in their entirety. Such references may provide sources of materials; alternative materials, details of methods, as well as additional uses of the invention.

1. A method of providing an ore concentrate solution suitable for beneficiation processing, the method including the step of (i) contacting an ore with one or more metal bases at elevated temperature.

2. A method according to claim 1 wherein the one or more metal bases are alkali metal bases, preferably chosen from lithium hydroxide, sodium hydroxide, potassium hydroxide, rubidium hydroxide or caesium hydroxide, or alkaline earth bases, preferably chosen from calcium hydroxide, barium hydroxide or strontium hydroxide.

3. A method according to claim 1 wherein the one or more metal bases at elevated temperature form a super-alkaline media that partially or fully dissolves the ore.

4. A method according to claim 1 wherein the one or more metal bases at elevated temperature form a super-alkaline media comprising 45 wt % to 100 wt % sodium hydroxide and/or potassium hydroxide.

5. A method according to claim 1 wherein the elevated temperature is 160° C. to 400° C., preferably 200° C. to 350° C., more preferably 250° C. to 350° C.

6. A method according to claim 1 wherein the ore is chosen from the group comprising one or more of: iron ore, preferably haematite, magnetite or goethite; aluminium containing ores; gold ores; manganese containing ores; lead ores; cobalt containing ores; uranium containing ores; copper containing; nickel containing ores, preferably nickel sulphide ores; silver containing ores; tin containing ores; silica ores and quartz.

7. A method according to claim 1 which further includes the step of adding silicates, preferably quartz, feldspar, mica, amphibole, pyroxene, olivine or aluminium-silicate to the combination of the ore and the one or more metal bases at elevated temperature.

8. A method according to claim 1 wherein the one or more metal bases at elevated temperature form a super-alkaline media, and the super-alkaline media is subjected to short term heating at high temperature to drive off water.

9. A method according to claim 1 wherein the ore concentrate is fed to a beneficiation process, preferably an extractive metallurgical process.

10. A method according to claim 1 wherein the ore concentrate is subjected to the further steps of:
(ii) extracting one or more components of the ore from the ore concentrate solution;
and optionally,
(iii) feeding the extracted ore concentrate solution to an extractive metallurgical process, preferably electrometallurgy, to deposit metal;
and optionally,
(iv) passing the extracted ore concentrate solution to further beneficiation processes.

11. A method according to claim 1 wherein the ore concentrate is subjected to the further steps of:
(ii) forming a solution comprising dissolved components from the ore concentrate;
(iii) removing the components from the ore concentrate solution;
and optionally
(iv) forwarding the purified solution from step (iii) to a downstream beneficiation process.

12. A concentrated ore produced by contacting an ore with one or more metal bases at elevated temperature.

13. A metal, recovered by a beneficiation process into which an ore concentrate is fed, wherein the ore concentrate is produced by contacting an ore with one or more metal bases at elevated temperature.
